(19) United States
(12) Patent Application Publication
(10) Pub. No.: US 2006/0209098 A1
(43) Pub. Date: Sep. 21, 2006

(54) Radiation curable ink-jet ink containing an alpha hydroxy ketone as photoinitiator

(76) Inventors: Andre Fuchs, Schlienhgen-Obereggenen (DE); Sebastien Villeneuve, Huningue (FR); Michelle q Richert, Illzach (FR)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/553,068

(22) PCT Filed: Apr. 6, 2004
(86) PCT No.: PCT/EP04/50450

§ 371 Date: Oct. 12, 2005

(30) Foreign Application Priority Data
Apr. 16, 2003 (EP) 03405266.2
Jul. 28, 2003 (EP) 03102322.9

(51) Int. Cl. B41J 2/01

(52) U.S. Cl. 347/1; 522/71

(57) ABSTRACT

A process for preparing an inkjet printed matter, which comprises the steps of applying an ultraviolet curable inkjet ink composition comprising a photopolymerizable monomer, oligomer or prepolymer; a colorant and a compound of the formula (I) or (II) or (Ia) or (IIa) or mixtures thereof, and optionally a reactive diluent to a recording medium and curing the ink composition on the recording medium by irradiating with ultraviolet ray.

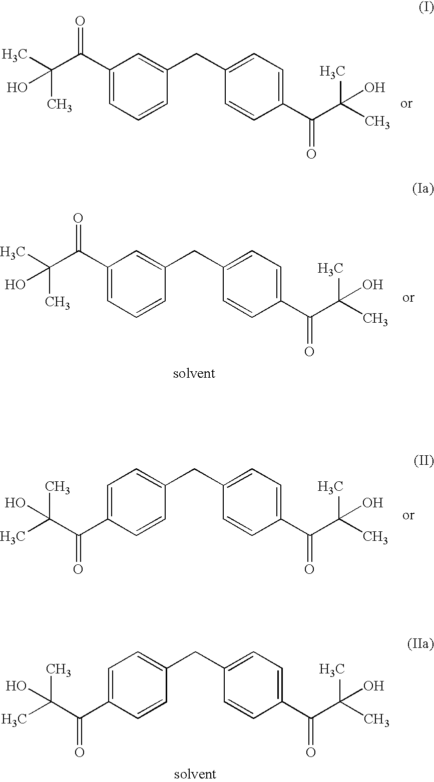

The present invention relates to a radiation curable ink-jet ink containing an alpha hydroxy ketone as photoinitiator.

In the ink-jet process, an image Is produced by ejecting ink droplets onto a recording material through a nozzle. The inks used in various ink jet printers can be classified as either dye-based or pigment-based.

A radiation curable ink jet ink composition may in general contain one or more radiation curable monomers, prepolymers or oligomers or reactive diluents; one or more photo-initiators, colorants and other additives. In formulating the final ink jet ink compositions of the present invention, certain physical properties should be satisfied. For example, ink compositions for use in ink jet recording processes should have appropriate viscosity of less than 50 mPas at ambient temperature, for example 1 to 40 mPas (millipascal-seconds) are preferred. The properties of the ink, such as viscosity, gloss, and crosslink density can be controlled by varying the types and/or proportions of reactive diluents used in the formulation.

Useful photoinitiators are, for example, alpha-hydroxyketones, such as 1-hydroxycyclo-hexyl phenyl ketone (IRGACURE 184), 2-hydroxy-2-methyl-1-phenyl-1-propanone (DAROCUR 1173) 1-[4-(2-hydroxyethoxy)-phenyl]-2-hydroxy-2-methyl-1-propane-1-one (IRGACURE 2959) or poly (2-hydroxy-2-methyl-1-[4-(1-methylvinyl)-phenyl]propan-1-one (available commercially as Esacure KIP 150, Fratelli Lamberti).IRGACURE and DAROCUR are commercial products of Ciba Specialty Chemicals Inc.

It has been found that a photoinitiator as disclosed in PCT Publication WO03/040076 improves the cure speed in UV curable inks.

Thus, the invention relates to a process for preparing an ink jet printed matter, which comprises the steps of applying an ultraviolet curable ink jet ink composition comprising
a photopolymeritable monomer, oligomer or prepolymer;
a colorant and a compound of the formula I or II or Ia or IIa 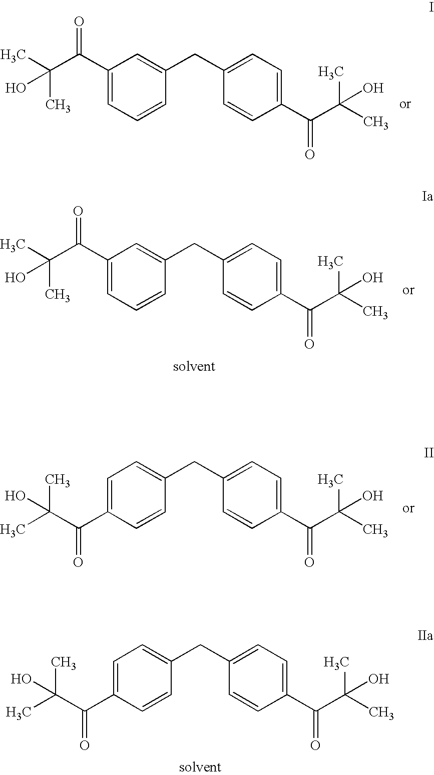
or mixtures thereof, and
optionally a reactive diluent
   to a recording medium and curing the ink composition on the recording medium by irradiating with ultraviolet ray.

The ink jet recording medium to which the ink composition of the present invention can be jetted is not limited and include e.g. paper, coated paper, polyolefin coated paper, cardboard, wood, composite boards, plastic, coated plastic, canvas, textile, metal, glass, and ceramics.

For the preparation of solvent-containing crystals there are suitable polar solvents, for example water, aliphatic alcohols, for example methanol, ethanol; amines, for example tertiary amines. The solvent is preferably water. The content of solvent (water) is from 2 to 8% by weight, preferably from 4 to 6% by weight.

In the preparation process, solvent-containing (water-containing) crystalline isomeric mixtures of the compounds of formulae Ia and IIa are initially formed, from which solvent-free isomeric mixtures are obtained by drying using drying agents.

The isomeric mixtures may contain the meta-para compound and the para-para compound in any ratio by weight. However, preference is given to an isomeric mixture having a content of para-para compound of from 99.9 to 25% by weight and having a content of meta-para compound of from 0.1 to 75% by weight. Special preference is given to an isomeric mixture having a content of para-para compound of from 99.9 to 70% by weight and having a content of meta-para compound of from 0.1 to 30% by weight.

Especially preferred is a mixture of compound Ia and IIa having a content of compound Ia of 1-2% and water content of 4-6%.

The preparation of the isomeric mixture is carried out according to the following scheme: 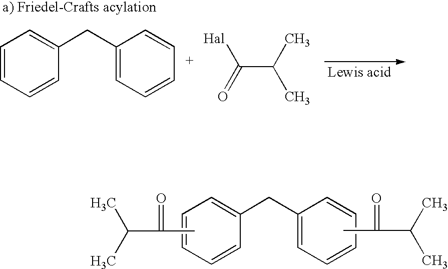
b) chlorination to bis(α-chloroisobutyryl)diphenylmethane,
c) hydrolysis to bis(α-hydroxyisobutyryl)diphenylmethane,
d) further processing to the solvent-containing crystalline isomeric mixture,
e) where appropriate, drying to form the solvent-free crystalline isomeric mixture.

Suitable monomers include those compounds which have at least one carbon-carbon unsaturated bond. Non limiting examples of such monomers include:
(meth)acrylic acid and salts thereof;
(meth)acrylic acid esters such as alkylesters e.g. methyl, ethyl, 2-chloroethyl, N-dimethylaminoethyl, n-butyl, isobutyl-, pentyl, hexyl, cyclohexyl, 2-ethylhexyl, octyl, isobornyl [2-exo-bomyl]esters;
phenyl, benzyl-, and o-, m- and p-hydroxyphenyl esters;
hydroxyalkylesters e.g. 2-hydroxyethyl, 2-hydroxypropyl, 4-hydroxybutyl, 3,4-dihydroxybutyl or glycerol [1,2,3-propanetriol] esters;
epoxyalkylesters e.g. glycidyl, 2,3-epoxybutyl, 3,4-epoxy butyl, 2,3-epoxycydohexyl, 10,11-epoxyundecyl esters;
(meth)acrylamides, N-substituted (meth)acrylamides, e.g. N-methylolacrylamide, N-methylolmethacrylamide, N-ethylacrylamide, N-ethylmethacrylamide, N-hexylacrylamide, N-hexylmethacrylamide, N-cylohexylacrylamide, N-cyclohexylmethacrylamide-, N-hydroxyethylacrylamide, N-phenylacrylamide, N-phenylmethacrylamide, N-brenzylacrylamide, N-benzylmetacrylamide, N-nitrophenylacrylamide, N-nitrophenylmethacrylamide, N-ethyl-N-phenylacrylamide, N-ethyl-N-phenylmethacrylamide, N-4-hydroxyphenyl)acrylamlde, and N-(4-hydroxyphenyl)methacrylamide, IBMAA (N-isobutoxymethyl acrylamide), (meth)acrylnitriles;
unsaturated acid anhydrides such as itaconic anhydride, maleic anhydride, 2,3-dimethyl maleic anhydride, and 2-chloromaleic anhydride,
unsaturated acid esters such as maleic acid esters, phthalic acid esters, itaconic acid esters, [methylene succinic acid esters];
styrenes, such as methyl styrene, chloromethyl styrene, and o-, m-, and p-hydroxystyrene, divnylbenzene;
vinyl chloride and vinylidene chloride;
vinyl ethers such as isobutyl vinyl ether, ethyl vinylether, 2-chloroethyl vinylether, hydroxyethyl vinylether, propyl vinylether, butyl vinylether, isobutyl vinyl ether, octyl vinylether and phenyl vinylether,
vinyl and allyl esters such as vinyl acetate, vinyl acrylate, vinyl chloroacetate, vinyl butyrate and vinyl benzoate, divinyl succinate, diallyl phthalate, triallyl phosphate;
isocyanurates such as triallyl isocyanurate and tris(2-acryloylethyl) isocyanurate;
N-vinyl heterocydic compounds, N-vinylpyrrolidone or suitably substituted vinylpyrrolidones, N-vinylcarbazol, N-vinylcaprolactam or suitably substituted vinylcaprolactames, 4-vinylpyridine.

Typical examples for esters are: diacrylates such as 1,6-hexane diol diacrylate (HDDA), ethylene glycol diacrylate, propylene glycol diacrylate, dipropylene glycol diacrylate, tripropylene glycol diacrylate, neopentyl glycol diacrylate, hexamethylene glycol diacrylate and bisphenol A diacrylate, trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol pentaacrylate, dipentaerythritol hexaacrylate, tripentaerythritol octaacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol trisitaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, pentaerythritol-modified triacrylate, sorbitol tetramethacrylate, sorbitol pentaacrylate, sorbitol hexaacrylate, oligoester acrylates and methacrylates, glycerol di- and tri-acrylate, 1,4-cyclohexane diacrylate, bisacrylates and bismethacrylates of polyethylene glycol having a molecular weight of from 200 to 1500, and mixtures thereof. The following esters of alkoxylated polyols are also suitable: glycerol ethoxylate triacrylate, glycerol propoxylate triacrylate, trimethylolpropane ethoxylate triacrylate, trimethylolpropane propoxylate triacrylate, pentaerythritol ethoxylate tetraacrylate, pentaerythritol propoxylate triacrylate, pentaerythritol propoxylate tetraacrylate, neopentyl glycol ethoxylate diacrylate, neopentyl glycol propoxylate diacrylate.

Non limiting examples of higher molecular weight (oligomeric) polyunsaturated compounds (also known as prepolymers) are esters of ethylenically unsaturated mono- or poly-functional carboxylic acids and polyols or polyepoxides, and polymers having ethylenically unsaturated groups in the chain or in side groups, e.g. unsaturated polyesters, polyamides and polyurethanes and copolymers thereof, alkyd resins; polybutadiene and butadiene copolymers, polyisoprene and isoprene copolymers, polymers and copolymers having (meth)acrylic groups in side chains such as methacrylated urethanes and also mixtures of one or more such polymers.

Examples of suitable mono- or poly-functional unsaturated carboxylic acids are acrylic acid, methacrylic acid, crotonic acid, itaconic acid, cinnamic acid, maleic acid, fumaric add, itaconic add, and unsaturated fatty acids such as linolenic acid and oleic acid. Acrylic and methacrylic acid are preferred.

It is also possible, however, to use saturated di- or poly-carboxylic acids in admixture with unsaturated carboxylic acids. Examples of suitable saturated di- or poly-carboxylic acids include, for example, tetrachlorophthalic acid, tetrabromophthalic acid, phthalic anhydride, adipic acid, tetrahydrophthalic acid, isophthalic acid, terepthalic acid, trimellitic acid, heptanedicarboxylic acid, sebacic acid, dodecanedicarboxylic acid, hexahydrophthalic acid, etc.

Suitable polyols are aromatic and, especially, aliphatic and cydoaliphatic polyols. Examples of aromatic polyols are hydroquinone, 4,4′-dihydroxydiphenyl, 2,2-di(4-hydroxyphenyl)propane, and novolaks and resols. Examples of polyepoxides are those based on the said polyols, especially the aromatic polyols and epichlorohydrin. Also suitable as polyols are polymers and copolymers that contain hydroxyl groups in the polymer chain or in side groups, e.g. polyvinyl alcohol and copolymers thereof or polymethacrylic acid hydroxyalkyl esters or copolymers thereof. Further suitable polyols are oligoesters having hydroxyl terminal groups.

Examples of aliphatic and cydoaliphatic polyols include alkylenediols having preferably from 2 to 12 carbon atoms, such as ethylene glycol, 1,2- or 1,3-propanediol, 1,2-, 1,3- or 1,4-butanediol, pentanediol, hexanediol, octanediol, dodecanediol, diethylene glycol, triethylene glycol, polyethylene glycols having molecular weights of preferably from 200 to 1500, 1,3-cyclopentanediol, 1,2-, 1,3- or 1,4-cydohexanediol, 1,4-dihydroxymethylcydohexane, glycerol, tris(β-hydroxyethyl)amine, trimethylolethane, trimethylolpropane, pentaerythritol, dipentaerythritol and sorbitol.

The polyols may be partially or fully esterified by one or by different unsaturated carboxylic acid(s), it being possible for the free hydroxyl groups in partial esters to be modified, for example etherified, or esterified by other carboxylic acids.

Preferred are:
(meth)acrylated epoxy esters
(meth)acrylated polyesters or vinyl-ether-group-containing polyesters,
(meth)acrylated polyurethanes, polyethers and polyols.

Aminoacrylates

A preferred component used in UV-curable inkjet are acrylates which have been modified by reaction with primary or secondary amines, as described, for example, in U.S. Pat. No. 3,844,916 of Gaske, in EP 280 222 of Weiss et al., in U.S. Pat. No. 5,482,649 of Meixner et al. or in U.S. Pat. No. 5,734,002 of Reich et al. Such amine-modified acrylates are also termed aminoacrylates. It is known that in the presence of aminoacrylates UV-curable systems show an increased curing performance. They are useful to overcome the oxygen inhibition typically observed for radical induced polymerization reactions, especially for low viscous systems like UV-curable inkjet. Aminoacrylates are obtainable, for example, under the name EBECRYL 80, EBECRYL 81, EBECRYL 83, EBECRYL P115, EBECRYL 7100 from UCB Chemicals, under the name Laromer PO 83F, Laromer PO 84F, Laromer PO 94F from BASF, under the name PHOTOMER 4775 F. PHOTOMER 4967 F from Cognis or under the name CN501, CN503, CN550 from Cray Valley or under the tradename Genomer 5275 from Rahn AG.

It will be clear that mixtures of all these cited monomers, prepolymers, polymers and oligomers can be used.

The amount of the photopolymerizable monomer, oligomer or prepolymer is, for example 10 to 80 wt %, preferably 10 to 60 wt %.

Especially emphazised are cationic-curable compositions having a low viscosity which comprise at least one aliphatic or aromatic epoxide, at least one polyol or polyvinyl polyols as mentioned above, and at least one cation-generating photoinitiator. A number of these epoxides are well known in the art and are commercially available.

The photoinitiators that can be used in the cationic photocurable compositions are, for example, aryl iodonium salts and aryl sulfonium salts.

U.S. Pat. No.6,306,555 describes diaryliodonium salts of formula 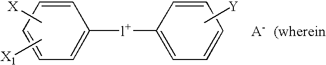
X is branched C₃-C₂₀alkyl or C₃-C₈cycloalkyl;
X₁ is hydrogen, linear C₁-C₂₀alkyl, branched C₃-C₂₀alkyl or C₃-C₈cycloalkyl; with the proviso that the sum of the carbon atoms in X and X₁ is at least 4;
Y is linear C₁-C₁₀allyl, branched C₃-C₁₀alkyl or C₃-C₈cycloalkyl;
A⁻ is a non-nucleophilic anion, selected from the group (BF₄)⁻, (SbF₈)⁻, (PF₈)⁻, (B(C₈F₅))₄⁻,
C₁-C₂₀alkylsulfonate, C₂-C₂₀haloalkylsulfonate, unsubstituted C₆-C₁₀arylsulfonate, camphorsulfonate, C₁-C₂₀-perfluoroalkylsulfonylimide, C₁-C₂₀-perfluoroalkylsulfonylimide, and C₆-C₁₀arylsulfonate substituted by halogen, NO₂, C₁-C₁₂alkyl, C₁-C₁₂halo-alkyl, C₁-C₁₂alkoxy or by COOR₁; and
R₁ is C₁-C₂₀alkyl, phenyl, benzyl; or phenyl mono- or poly-substituted by C₁-C₁₂alkyl, C₁-C₁₂alkoxy or by halogen.

The commercially available bisaryl iodonium salts are Irgacure 250 (iodonium, (4-methylphenyl)[4(2-methylpropyl)-phenyl]-, hexafluorophosphate(1-) from Ciba Specialty Chemicals), CD 1012 (Sartomer), UV 9380C (GE Bayer Silicones), Rhodorsil 2074 (Rhodia) etc, and triaryl sulfonium salts are UVI-6990, UVI-6974 (Union Carbide) etc.

Emphasized are hybrid systems that contain cationically and radically polymerisable and photopolymerisable raw materials. Examples of cationically polymerisable systems include cyclic ethers, especially epoxides and oxetanes, and also vinyl ethers and hydroxy-containing compounds. Lactone compounds and cyclic thioethers as well as vinyl thioathers can also be used. Further examples include aminoplastics or phenolic resole resins. These are especially melamine, urea, epoxy, phenolic, acrylic, polyester and alkyd resins, but especially mixtures of acrylic, polyester or alkyd resins with a melamine resin. Radiation curable resins contain ethylenically unsaturated compounds, especially (meth)acrylate resins.

Furthermore emphasized are hybrid systems that are photopolymerized in a first stage and then crosslinked through thermal post-treatment in a second stage. Such hybrid systems comprise an unsaturated compound in mixtures with non-photopolymerizable film-forming components. These may, for example, be physically drying polymers or solutions thereof in organic solvents, for example nitrocellulose or cellulose acetobutyrate. However, they may also be chemically or thermally curable resins, for example polylsocyanates, polyepoxides or melamine resins.

Furthermore emphasized are dual cure systems, which are cured first by heat and subsequently by UV or electron irradiation, or vice versa, and whose components contain ethylenic double bonds as described above capable to react on irradiation with UV light in presence of a photoinitiator.

Sometimes, it is also desirable to include, in addition to the primary photoinitiator, an additional photoinitiator and/or a co-initiators or synergists, for example photosensitisers that shift or broaden the spectral sensitivity. These include especially aromatic carbonyl compounds, for example benzophenone, thioxanthone, including especially isopropylthioxanthone, anthraquinone and 3-acylcoumarin derivatives, terphenyls, styryl ketones, and 3-(aroylmethylene)thiazolines, camphorquinone and also eosin, rhodamine and erythrosine dyes.

Additional photoinitiators may be e.g. IRGACURE 184, 651, 369, 1700, 1800, and 1850 and DAROCUR 1173 and 4265 from Ciba-Specialty Chemicals INC.

The photoinitiator and occasionally the coinitiator are preferably present in an amount from 0.2 to 20% by weight and most preferably between 1 and 10%.

Ink jet inks of the present invention contain a colorant. A wide variety of organic and inorganic dyes and pigments, alone or in combination may be selected for use in the ink jet ink compositions of this invention. The pigment particles should be sufficiently small (0.005 to 15 μm) to permit free flow of the ink at the ejecting nozzles. The pigment particles should preferably be 0.005 to 1 μm.

Very fine dispersions of pigments and their preparation are disclosed in e.g. U.S. Pat. No. 5,538,548.

The inks preferably comprise a total content of colorant of 1 to 35% by weight, in particular 1 to 30% by weight, and preferably 1 to 20% by weight, based on the total weight of ink. A limit of 2.5% by weight, in particular 5% by weight, and preferably 7.5% by weight, is preferred here as the lower limit.

Suitable colorants are for example pure pigment powders such as Cyan Irgalite Blue GLO (Ciba Specialty Chemicals) or pigment preparations such as MICROLITH-pigment preparations.

The pigment can be black, white, cyan, magenta, yellow, red, blue, green, brown, mixtures thereof, and the like. For example, suitable pigment materials include carbon blacks such as Regal 400R, Mogul L, Elftex 320 from Cabot Colo., or Carbon Black FW18, Special Black 250, Special Black 350, Special Black 550, Printex 25, Printex 35, Printex 55, Printex 150T from Degussa Co., and Pigment Black 7. Additional examples of suitable pigments are disclosed in, for example, U.S. Pat. No. 5,389,133.

Suitable white pigments are titanium dioxide (modifications rutil and anatas), e.g. KRONOS 2063 from Kronos, or HOMBITAN R610 L from Sachtleben.

Suitable pigments include, for instance, C. I. Pigment Yellow 17, C. I. Pigment Blue 27, C. I. Pigment Red 49:2, C. I. Pigment Red 81:1, C. I. Pigment Red 81:3, C. I. Pigment Red 81:x, C. I. Pigment Yellow 83, C. I. Pigment Red 57:1, C. I. Pigment Red 49:1, C. I. Pigment Violet 23,C. I. Pigment Green 7, C. I. Pigment Blue 61, C. I. Pigment Red 48:1, C. I. Pigment Red 52:1, C. I. Pigment Violet 1,C. I. Pigment White 6,C. I. Pigment Blue 15, C. I. Pigment Yellow 12, C . Pigment Blue 56, C. I. Pigment Orange 5, C. I. Pigment Black, C. I. Pigment Yellow 14, C. I. Pigment Red 48:2, C. I. Pigment Blue 15:3, C. I. Pigment Yellow 1, C. I. Pigment Yellow 3,C. I. Pigment Yellow 13,C. I. Pigment Orange 16,C. I. Pigment Yellow 55, C. I. Pigment Red 41, C. I. Pigment Orange 34, C. I. Pigment Blue 62, C. I. Pigment Red 22, C. I. Pigment Red 170, C. I. Pigment Red 88, C. I. Pigment Yellow 151, C. I. Pigment Red 184, C. I. Pigment Blue 1:2, C. I. Pigment Red 3, C. I. Pigment Blue 15:1, C.I. Pigment Blue 15:3, C.I. Pigment Blue 15:4, C. I. Pigment Red 23, C. I. Pigment Red 112, C. I. Pigment Yellow 126, C. I. Pigment Red 169, C. I. Pigment Orange 13, C. I. Pigment Red 1-10, 12, C.I. Pigment Blue 1:X, C.I. Pigment Yellow 42, C.I. Pigment Red 101, C.I. Pigment Brown 6, C. I. Pigment Brown 7, C. I. Pigment Brown 7:X, C. I. Pigment Black 11, C. I. Pigment Metal 1, C. I. Pigment Metal 2, C.I. Pigment Yellow 128, C.I. Pigment Yellow 93, C.I. Pigment Yellow 74, C.I. Pigment Yellow 138, C.I. Pigment Yellow 139, C.I. Pigment Yellow 154, C. I. Pigment Yellow 185, C.I. Pigment Yellow 180, C.I. Pigment Red 122, C.I. Pigment Red 184, and bridged aluminum phtalocyanine pigments, C. I. Pigment Red 254, C. I. Pigment Red 255, C.I. Pigment Red 264, C. I. Pigment Red 270, C0.. Pigment Red 272, C. I. Pigment Violet 19, C.I. Pigment Red 166, C.I. Pigment Red 144C. I. Pigment Red 202, C. I. Pigment Yellow 110, C. I. Pigment Yellow 128, C. I. Pigment Yellow 150, C. I. Pigment Orange 71,C. I. Pigment Orange 64,C. I. Pigment Blue 60.

The pigment may, but need not, be in the form of a dispersion comprising a dispersant also called pigment stabilizer. The latter may be, for example, of the polyester, polyurethane of polyacrylate tope, especially in the form of high molecular weight block copolymer, and would typically be incorporated at 2.5% to 100% by weight of the pigment An example of a polyurethane dispersant is EFKA 4047.

Further pigment dispersions are (UNISPERSE, IRGASPERSE) and ORASOL Dyes (solvent soluble dyes): C.I. Solvent Yellow 146, C.I. Solvent Yellow 88, C.I. Solvent Yellow 89, C.I. Solvent Yellow 25, C.I. Solvent Orange 11, C.I. Solvent Orange 99, C.I. Solvent Brown 42, C.I. Solvent Brown 43, C.I. Solvent Brown 44, C.I. Solvent Red 130,C.I. Solvent Red 233, C.I. Solvent Red 125, C.I. Solvent Red 122, C.I. Solvent Red 127, C.I. Solvent Blue 136, C.I. Solvent Blue 67, C.I. Solvent Blue 70, C.I. Solvent Black 28, C.I. Solvent Black 29

Especially emphazised are the MICROLITH-pigment preparations commercially available from Ciba Specialty Chemicals Inc. These pigment dispersions may be organic or inorganic pigments predispersed in a variety of resins, e.g. in vinyl resins, acrylic resins and aromatic polyurethane resins. MICROLITH-WA may for example be a line of pigments predispersed in alkaline water/alcohol soluble acrylic resin (specially developed for aqueous gravure and flexographic printing) with pigments that may be compatible with UV and ink jet printing inks.

The Microlith-K ink jet products are used in vinyl-based inks, which can be formulated to give good adhesion to many substrates, from plasticized and rigid PVC, metal foils, to polymer coated regenerated cellulose films.

Ink Jet inks of the present invention may also more generally include others pigments preparation like chips or in situ combination during grinding of pigments (as described above) and hyperdispersants (e.g. Solsperse as available from Avecia) into the binder carrier.

Other Additives

Ink jet inks of the present invention may include additives such as surfactants, biocides, buffering agents, anti-mold agents, pH adjustment agents, electric conductivity adjustment agents, chelating agents, anti-rusting agents, polymerisation inhibitors, light stabilizers, and the like. Such additives may be included in the ink jet inks of the present invention in any effective amount, as desired.

Compositions according to the present invention may contain organic solvents, for example, ketones, ethers and esters, such as methyl ethyl ketone, isobutyl methyl ketone, cyclopentanone, cyclohexanone, N-methylpyrrolidone, dioxane, tetrahydrofuran, 2-methoxyethanol, 2-thoxyethanol, 1-methoxy-2-propanol, 1,2-dimethoxyethane, ethyl acetate, n-butyl acetate and ethyl 3-ethoxypropionate or 1-isopropyl-2,2-dimethyltrimethylendiisobutyrate available as TXIB from Eastman.

The reactive diluent in the ultraviolet ray curable ink and the ultraviolet ray curable ink composition for ink jet of the present invention is a monomer which has at least one double bond reactive group at the molecule terminal. Examples thereof are monofunctional caprolactone acrylate, tridecyl acrylate, isodecyl acrylate, isooctyl acrylate, isomiristyl acrylate, isostearyl acrylate, 2-ethylhexyl-diglycol acrylate, 2-hydroxybutyl acrylate, 2-acryloyloxyethyl hexahydrophthalic acid, neopentyl glycol acrylic acid benzoic acid ester, isoamylacylate, lauryl acrylate, stearyl acrylate, butoxyethyl acylate, ethoxy-diethylene glycol acrylate, methoxy-triethylene glycol acrylate, methoxy-polyethylene glycol acrylate, methoxydipropyleneglycol acrylate, phenoxyethyl acrylate, phenoxy-polyethylene glycol acrylate, nonylphenol ethylene oxide adduct acrylate, tetrahydrofurfuryl acrylate, isobonyl acrylate, 2-hydroxyethyl acrylate, 2-hydroxypropyl acrylate, 2-hydroxy-3-phenoxypropyl acrylate, 2-acryloyloxyethyl succinic acid, 2-acryloyloxyethylphthalic acid and 2-acryloyloxyethyl-2-hydroxyethylphthalic acid; difunctional hydroxypivalic acid neopenthylglycol diacrylate, polytetramethylene glycol diacrylate, trimethylol propane acrylic acid benzoic acid ester, diethylene glycol diacrylate, triethylene glycol diacrylate, tripropylene glycol diacrylate, tetraethylene glycol diacrylate, polyethylene glycol (200) diacrylate, polyethylene glycol (400) diacrylate, polyethylene glycol (600) diacrylate, polyethylene glycol (1000) diacrylate, polypropylene (400) diacrylate, polypropylene (700) diacrylate, neopentyl glycol diacrylate, 1,3-butanediol diacrylate, 1,4-butanediol diacrylate, 1,6-hexanediol diacrylate, 1,9-nonanediol diacrylate, dimethylol-tricydodecane diacrylate, bisphenol A ethylene oxide adduct diacrylate and bisphenol A propyleneoxide adduct diacrylate; trifunctional trimethylolpropane triacrylate, ethylene oxide modified trimethyl propane triacrylate, ethylene oxide modified trimethylolpropane triacrylate, pentaerythritol tiacrylate, tris(2-hydroxyethyl)isocyanurat-e triarylate and propoxylated glyceril triacrylate; tetrafunctional pentaditrimethylol propane tetraacrylate, ethoxylated pentaerythritol tetraacrylate, pentaerythritol tetraacrylate; pentafunctional dipentaerythritol hydroxypentaacrylate; and hexafunctional dipentaerythritol hexaacrylate; and modifications thereof. These can be used alone or in a combination.

The amount of the reactive diluent is, for example, 10 to 90 wt %, preferably 40 to 80 wt %.

Devices used for radiation curing are known to those skilled in the art and are commercially available. For example, the curing proceeds with high-, medium- and low-pressure mercury radiators, mercury vapour lamps or pulsed xenon lamps. An intensity of 40 to 240 W/cm in the 200-400 nm region is usually employed.

Further examples are: microwave-excited metal vapour lamps, excimer lamps, superactinic fluorescent tubes, fluorescent lamps, argon incandescent lamps, flash lamps, e.g. high-energy flash lamps, photographic floodlight lamps, light-emitting diodes (LED), electron beams and X-rays, laser light sources, for example excimer lasers. The distance between the lamp and the substrate to be exposed may vary according to the intended use and the type and strength of the lamp and may be, for example, from 2 cm to 150 cm.

### EXAMPLE 1

### According to PCT Publication WO03/040076

### Preparation of a Crystalline Isomeric Mixture (Formulae Ia and IIa) Containing Water of Crystallisation

1.1) Friedel-Crafts Reaction

109.4 g (0.65 mol) of diphenylmethane, 159.3 g (1.495 mol) of isobutyric acid chloride and 150 ml of 1,2-dichlorobenzeng are combined and cooled to 5-0° C. In the course of about four hours, 208.0 g (1.56 mol) of aluminium chloride are added in small portions at an internal temperature of 5-0° C. HCl gas is evolved. Stirring is then carried out for about 16 hours at an internal temperature of 0-5° C. At the end of that period, all the aluminium chloride has dissolved. The dark-red reaction mixture is then poured onto ice and water and stirred to complete the reaction. The two phases are separated in a separating funnel. The organic phase is washed with water and then concentrated for a short time in a vacuum rotary evaporator at about 60° C. and about 25 mbar. 403.1 g of a yellow liquid are obtained. The product, an isomeric mixture with bis[4-(2-methyl-propionylyphenyl]-methane as the main component, is used in the next reaction without being purified further. Excluding the solvent 1,2-dichlorobenzene, 87.3% p,p-isomer, 11.4% m,p-isomer, 0.66% m,m-isomer and 0.60% p-mono compound are found in the GC and ¹H-NMR spectrum.

1.2) Enol Chlorination

403.1 g (0.65 mol) solution of the isomeric mixture of bis[4-(2-methyl-propionylyphenyl]-methane with [3-2-methyl-propionylyphenyl]-[4-(2-methyl-propionyl)-phenyl]-methane from the Friedel-Crafts reaction are heated to 55-60° C. by means of an oil bath. 92.2 g (1.30 mol) of chlorine gas are then introduced through a glass frit at 55-60° C., with thorough stirring, more rapidly at the beginning and only slowly at the end. HCl gas is evolved. The duration of the introduction is about 6 hours. 441.5 g of a yellowish liquid are obtained. The product, an isomeric mixture with bis[4-2-chloro-2-methyl-propionyl)-phenyl]-methane as the main component, is used in the next reaction without being purified further. Excluding the solvent 1,2-dichlorobenzene, about 87% p,p-isomer and about 12% m,p-isomer are found in the ¹H-NMR spectrum.

1.3) Hydrolysis

Variant 1.3a

Rapid Crystallisation for Working-Up of the Hydrolysis Product

208.0 g (1.56 mol) of NaOH concentrated to 30% and 208 ml of deionised water and 205.7 g of methanol are combined. There are then added dropwise at 50° C. in a period of about one hour, with thorough stirring, 441.5 g (0.65 mol) of a solution, in 1,2-dichlorobenzene, of the isomeric mixture of bis[4-(2-chloro-2-methyl-propionyl)-phenyl]-methane with [3-(2-chloro-2-methyl-proplonyl)-phenyl]-[4-(2-chloro-2-methyl-proplonyl)-phenyl]-methane from the chlorination reaction, additionally diluted with 102.8 g of methanol. The internal temperature slowly rises to 55-60° C. The alkaline mixture (about pH 12) is then stirred for about three to four hours at 55-60° C. The conversion is checked with a GC sample and a ¹H-NMR sample. The mixture is then cooled to 45° C. and adjusted dropwise to a pH of about 2-3 with about 63.5 g of 16% hydrochloric acid. The colour of the emulsion changes from a strong yellow to yellow. The mixture is then stirred for about 30 minutes. When the hydrolysis is complete, the reaction mixture is neutralised with a small amount of dilute sodium hydroxide solution. The two phases are separated at about 50° C. in a separating funnel. 200 ml of water are added to the organic phase, which is then stirred and separated off again. The organic phase is the solution of an isomeric mixture with bis[4-(2-hydroxy-2-methyl-propionyl)-phenyl]-methane as the main component. About 88% p,p-isomer and about 11% m,p-isomer are found in the ¹H-NMR spectrum. The warm organic phase is diluted with solvent (400 ml of toluene), and a small amount of water (about 23 g of water, about 10% of the amount of end product) is added thereto. The solution is seeded at 40-35° C. with water-containing crystals and is later cooled after the crystallisation. The thick suspension is filtered and washed with toluene and hexane in order to displace the 1,2-dichlorobenzene. The crystals are dried in vacuo to constant weight 177.7 g of white crystals containing water of crystallisation are obtained. This corresponds to a yield of 76.3% of theory (358.44) over all three reaction steps. The crystals of the isomeric mixture melt at 68-70° C. and contain 5.02% by weight water. The crystals exhibit an X-ray powder spectrum with the characteristic lines at a 2-theta angle of 6.69; 9.67; 13.95; 15.11; 16.35; 17.57; 19.43; 21.39; 22.17; 23.35; 25.93; 27.11; 27.79; 28.73; 34.83; 41.15.

Variant 1.3b

Slow Crystallisation for Working-Up of the Hydrolysis Product

The isomeric mixture obtained in Example 1.2 is hydrolysed analogously to Variant 1.3a. About 88% p,p-isomer (bis[4-(2-hydroxy-2-methyl-propionyl)-phenyl]-methane) and about 11% m,p-isomer are found in the GC and ¹H-NMR spectrum. After separating the organic phase and the aqueous phase, the warm organic phase (about 55° C.) is diluted with 250 ml of toluene, and about 30 g of water are then added thereto. The solution begins to crystallise spontaneously at 36° C., and the temperature rises to 42° C. The suspension, which has thickened, is diluted with 75 ml of toluene and stirred for one hour without cooling. The experiment is left to stand overnight and on the following morning is cooled to 5° C. using an ice-water bath. The cold, thick suspension is filtered and washed with 75 ml of toluene and 140 g of hexane mixture in order to displace the 1,2-dichlorobenzene. The moist filtration product is weighed, 204.5 g of moist white crystals, and halved. A portion of the crystals is immediately dried, a portion of the crystals is subjected to after-treatment. The mother liquor and the solvent used for washing are together concentrated in vacuo. 45.5 g of brown liquid residue are obtained. About 42% p,p-isomer and about 58% m,p-isomer, determined by evaluation of the integrals of the aromatic protons, are found in the ¹H-NMR spectrum.

The 102.3 g of white crystals are dried in vacuo to constant weight. 88.1 g of white, flocculent, voluminous crystals containing water of crystallisation are obtained. This corresponds to a yield of 75.6% of theory (358.44) over all three reaction steps. The crystals of the isomeric mixture melt at 71-74° C. and contain 5.12% by weight water according to Karl Fischer water determination.

Variant 1.3c

After-Treatment

The other half, 102.2 g of moist white crystals, is dissolved with 150 g of toluene and heated for distillation. 68 g of toluene and 15 g of water are distilled off, final temperature about 110° C. in the solution. The solution is slowly cooled and left to stand overnight. On the following morning, all the material is still dissolved. The solution is seeded with water-free crystals, with stirring. It slowly crystallises out. The suspension is later diluted with 60 g of toluene, then cooled to 5° C., filtered and washed with 90 g of toluene. The white crystals are dried in vacuo to constant weight. 71.7 g of white, hard, compact crystals are obtained. This corresponds to a yield of 64.8% of theory (340.42) over all three reaction steps. The crystals of the isomeric mixture melt at 87-90° C. and contain 2.02% by weight water according to Karl Fischer water determination. The mother liquor and the solvent used for washing are together concentrated in vacuo. 12.3 g of yellowish oil are obtained.

Variant 1d

Change of Solvent Before the Hydrolysis

1d.2) Enol Chlorination

Analogously to Example 1, the Friedel-Crafts reaction and the enol chlorination are carried out with 1,2-dichlorobenzene as solvent. 460.6 g of a yellowish liquid are obtained. The product, an isomeric mixture with bis[4-(2chloro-2-methyl-propionyl)-phenyl]-methane as the main component, is freed of the solvent 1,2-dichlorobenzene by means of steam distillation before the next reaction. The head temperature in the distillation is about 95° C. and the distillation lasts about 4 hours. About 145 ml of 1,2-dichlorobenzene are recovered. The residue, a yellowish emulsion, is diluted with 195 g of toluene and separated from the water while still warm. There are obtained 462.7 g of organic phase, which is used in the next reaction without being purified further. Excluding the new solvent toluene, about 87% p,p-isomer and about 12% m,p-isomer are found in the GC and ¹H-NMR spectrum.

1d.3) Hydrolysis

208.0 g (1.56 mol) of NaOH concentrated to 30% and 208 ml of deionised water and 205.7 g of methanol are combined. The temperature rises to about 38° C. The mixture is then heated to 50° C. by means of an oil bath. There are then added dropwise in a period of about one hour, with thorough stirring, 462.7 g (0.65 mol) of a solution, in toluene, of the isomeric mixture of bis[4-(2-chloro-2-methyl-propionylyphenyl]-methane with [3-(2-chloro2-methylpropionyl)-phenyl]-[4-(2-chloro-2-methyl-proplonylyphenyl]-methane from the chlorination reaction, additionally diluted with 103 g of methanol. The internal temperature slowly rises to 55-60° C. The alkaline mixture (about pH 11) is then stirred for about three to four hours at 55-60° C. The conversion is checked with a ¹H-NMR sample. The mixture is then cooled to 27° C. and adjusted dropwise to a pH of about 1-2 with about 73.4 g of 16% hydrochloric acid. The colour of the emulsion changes from red to reddish. The mixture is then stirred for about 100 minutes at 55-60° C. When the hydrolysis is complete, the reaction mixture is neutralised with about 9.4 g of dilute sodium hydroxide solution (15%). The two phases are separated at about 50° C. in a separating funnel. 200 ml of toluene and 200 ml of water are added to the organic phase, which is then stirred and separated off again. The organic phase is an isomeric mixture with bis[4-(2-hydroxy-2-methyl-propionylyphenyl]-methane as the main component About 88% p,p-isomer and about 11% m,p-isomer are found in the GC and ¹H-NMR spectrum. The warm organic phase is again diluted with 300 ml of toluene, and then about 30 g of water are added thereto. The solution is seeded at 40-35° C. with water-containing crystals and is later heated to about 50° C. after the crystallisation. The thick suspension is slowly cooled and later cooled further by means of an ice-water bath. It is then filtered and washed with 200 ml of toluene. The white crystals are dried in vacuo to constant weight. 173.1 g of white, voluminous crystals containing water of crystallisation are obtained. This corresponds to a t.q. yield of 74.3% of theory (358.44) over all three reaction steps. The crystals of the isomeric mixture melt at 70.6-71.7° C. and contain 4.8% by weight water according to Karl Fischer water determination.

The mother liquor and the solvent used for washing are together concentrated in vacuo. 47.7 g of residue, a reddish viscous oil, are obtained.

1d.4) Enol Chlorination

Analogously to Example 1.1 and 1.2, the Friedel-Crafts reaction and the enol chlorination are carried out using 1,2-dichlorobenzene as solvent 457.2 g of a yellowish liquid are obtained. The product, an isomeric mixture with bis[4-(2-chloro-2-methyl-propionyl)-phenyl]-methane as the main component, is freed of the solvent 1,2-dichlorobenzene before the next reaction by means of steam distillation. The head temperature in the distillation is about 95° C. and the distillation lasts about 4 hours. About 150 ml of 1,2-dichlorobenzene are recovered. The residue, a yellowish emulsion, is diluted with 195 g of toluene and separated from the water while still warm. There are obtained 459.7 g of organic phase, which is used in the next reaction without being purified further. Excluding the new solvent toluene, about 87% p,p-isomer and about 12% m,p-isomer are found in the GC and ¹H-NMR.

1d.5) Hydrolysis

459.7 g (0.65 mol) of a solution, in toluene, of the isomeric mixture of bis[4-chloro-)2-methyl-propionyl)-phenyl]-methane with [3-(2-chloro-2-methyl-proplonyly)-phenyl]-[4-(2-chloro-2-methyl-propionyl)-phenyl]-methane from the chlorination reaction are introduced into a reaction flask and diluted with 308.5 g of methanol. The mixture is then heated to 50° C. by means of an oil bath. 208.0 g (1.56 mol) of NaOH concentrated to 30% are then added dropwise in a period of about one hour, with thorough stirring. The internal temperature slowly rises to 55-60° C. The alkaline mixture (about pH 11) is then stirred for about 3 hours at 55-60° C. The conversion is checked with a ¹H-NMR sample. The mixture is then cooled to 40° C. and adjusted dropwise to a pH of about 1-2 with about 58.2 g of 16% hydrochloric acid. The colour of the emulsion changes from red to reddish. The mixture is then stirred further for about 2 hours at 55-60° C. When the hydrolysis is complete, the reaction mixture is neutralised with about 4.3 g of dilute sodium hydroxide solution (15%). The two phases are separated at about 50° C. in a separating funnel. 200 ml of toluene and 200 ml of water are added to the organic phase, which is then stirred and separated off again. About 88% p,p-isomer and about 11% m,p-isomer are found in the ¹H-NMR spectrum. The warm organic phase is diluted again with 300 ml of toluene, and then about 30 g of water are added thereto. The solution begins to crystallise out at 38° C. and is later heated to about 50° C. again after the crystallisation. The suspension is slowly cooled and later cooled further by means of an ice-water bath. It is then filtered and washed with 200 ml of toluene. The white crystals are dried in vacuo to constant weight 180.5 g of white crystals containing water of crystallisation are obtained. This corresponds to a t.q. yield of 77.5% of theory (358.44) over all three reaction steps. The crystals of the isomeric mixture melt at 72.1-74.7° C. and contain 4.7% by weight water according to Karl Fischer water determination. The overall content of meta-para compound in the crystals is determined indirectly at the end of Example 1e.

1d.5a) Purification of the Mother Liquor

The mother liquor and the solvent used for washing are together concentrated in vacuo. 40.0 g of a reddish viscous oil are obtained. The oil is purified by means of flash chromatography over silica gel 60 (0.040-0.063 mm) from Merck. A mixture of ethyl acetate:hexane mixture 1:2 is used as eluant. 28.5 g of yellow-reddish oil are isolated as the main fraction. It is a pure product in the thin-layer chromatogram. About 36% p,p-isomer and about 64% m,p-isomer, determined by evaluation of the integrals of the aromatic protons, are found in the ¹H-NMR spectrum.

Variant 1e

Determination of the Distribution of Isomers After Crystallisation

Analogously to Example 1, diphenylmethane is acylated with isobutyric acid chloride in 1,2-dichlorobenzene, the diketone mixture is then chlorinated without intermediate purification, and hydrolysis is finally carried out with sodium hydroxide solution and with the addition of methanol. The distribution of isomers between the para-para compound and the meta-para compound, about 12% meta-para compound, is maintained over all three steps, because no product is separated off until crystallisation. After separation of the aqueous phase, toluene and water are added analogously to Example 1.3b. The solution crystallises out at about 30° C. It is heated again to about 50° C., until almost all the material has dissolved, and the suspension is then stirred while cold. On the following morning, the mixture is cooled to 5° C. by means of an ice-water bath and then filtered after 5 hours. The crystals are washed with toluene and hexane mixture in order to displace the 1,2-dichlorobenzene. The 173.2 g of white crystals are dried in vacuo at about 30° C. to constant weight 148.4 g of fine-grained white crystals containing water of crystallisation are obtained. This corresponds to a yield of 78.6% of theory (358.44) over all three reaction steps (0.5265 mol). The crystals of the Isomeric mixture melt at 71-73° C. and contain 4.6% by weight water according to Karl Fischer water determination. After several weeks, the melting range stabilises at 76.0-77.5° C.

The mother liquor, 528 g of yellowish solution, is concentrated in a vacuum rotary evaporator and then freed of solvent 1,2-dichlorobenzene by means of steam distillation. The head temperature in the distillation is about 95° C. and the distillation lasts about one hour. The oil is separated from the water and then freed of solvent completely at about 60° C. and under a good vacuum (0.5 mbar). 36.7 g of thick brownish oil are obtained. About 42% p,p-isomer and about 58% m,p-isomer, determined by evaluation of the integrals of the aromatic protons, are found in the ¹H-NMR spectrum of the concentrated mother liquor.

The crystals have only a small amount of m,p-isomer in the ¹H-NMR spectrum. The proportion of meta-para compound in the crystals was for a long time uncertain because of the resonances of the secondary products and the traces of 1,2-dichlorobenzene, which occur at the same locations in the ¹H-NMR spectrum. Without removal of 1,2-dichlorobenzene by prior steam distillation, the integral for the meta-para isomer in the ¹H-NMR spectrum is not visible.

In order better to determine and monitor the distribution of isomers between the para-para compound and the meta-para compound in the crystals, a larger sample is recrystallised from toluene and water. The exact procedure is as follows:

A sample of 120.0 g of crystalline product from Example 1e is dissolved in 180 g of toluene at 55° C., and 20 g of water are added thereto. The solution is then allowed to cool slowly, with stirring. It crystallises at about 49° C., with a rise in temperature to about 56° C. It is stirred overnight, without cooling, to complete the reaction and is then cooled to about 5° C. After two hours, filtration through a suction filter is carried out. The filtration product is washed with 30 g of cold toluene and dried in vacuo in a drying cabinet between room temperature and 40° C. There are obtained 118.3 g of hard white crystals, which melt at 74-79° C. The toluenic mother liquor (about 195 g) is concentrated and dried. There remain 1.7 g of yellowish oil, which shows about 60% meta-para compound in the ¹H-NMR spectrum (300 MHz). This corresponds to 1.0 g of meta-para compound, which corresponds to a content of about 0.85% of meta-para compound in the crystals used. A further analogous recrystallisation of a sample of 100 g of the obtained crystals from toluene and water gives a toluenic filtrate which, after concentration to 4.6 g of colourless oil, shows about 2.0% of meta-para compound in the ¹H-NMR spectrum. This corresponds to 0.1 g of meta-para compound, which corresponds to a content of about 0.10% of metapara compound in the crystals used. The two contents of about 0.85% and about 0.10% are added together, and the total content of meta-para compound in the tested crystals is from about 0.9% to about 1.0%. This estimate is now sufficiently accurate.

In an analogous manner, a sample of 120.0 g of crystalline product from Example 1d.5 is dissolved in 180 g of toluene at 62° C., and 23 g of water are added thereto. The solution is cooled and crystallised in the same manner. The suspension is stirred overnight to complete the reaction, and is then filtered at room temperature. The crystals are washed with 90 g of toluene and dried in vacuo in a drying cabinet between room temperature and 40° C. There are obtained 114.1 g of hard white crystals, which melt at 70-76° C. The toluenic mother liquor is concentrated and dried. There remain 5.1 g of yellowish oil, which shows about 36% meta-para compound in the ¹H-NMR spectrum (300 MHz). This corresponds to 1.84 g of meta-para compound, which corresponds to a content of about 1.5% meta-para compound, which was extracted from the crystals used. The total content of meta-para compound in the tested crystals is estimated at from about 1.5% to about 1.7%. The direct estimation of the total content of meta-para compound from the ¹H-NMR spectrum (300 MHz) by evaluation of the integrals of the aromatic protons is no longer reliable with such small amounts.

Variant 1f

Change of solvent after hydrolysis and adjustment of the ratio of isomers in the crystals Analogously to Example 1, diphenylmethane is acylated with isobutyric acid chloride in 1,2-dichiorobenzene, then the diketone mixture is chlorinated without intermediate purification, and hydrolysis is finally carried out with sodium hydroxide solution and with the addition of methanol. The distribution of isomers in the reaction mixture between the para-para compound and the meta-para compound, about 12% meta-para compound, is maintained over all three steps, because no product is separated off until crystallisation. After separation of the aqueous phase, the organic phase, in a modification of Example 1, is subjected to steam distillation at about 95-100° C., and the 1,2-dichlorobenzene is removed. About 154 g of 1,2-dichlorobenzene are recovered. There is obtained a thick yellow oil, which tends to crystallise with water below 60° C. The oil is crystallised with a large amount of water without further solvent. Slow cooling yields moist, light-yellow spherules, which are filtered off and dried in vacuo at about 35-40° C. In the ¹H-NMR spectrum of the crystals, the distribution of isomers between the para-para compound and the meta-para compound is the same as in the ¹H-NMR spectrum of a sample of the oil, i.e. about 88% para-para isomer and about 12% meta-para isomer. It no longer contains any 1,2-dichlorobenzene to interfere with the evaluation of the ¹H-NMR spectrum. The light-yellow crude product is also surprisingly pure in the TLC. There are obtained 222.9 g of yellowish granules, which melt at 63-72° C. This corresponds to a yield of 95.7% over three reaction steps with a starting batch size of 0.65 mol (Example 1f).

From that crude product, by means of controlled crystallisations from water with variously small additions of toluene, it is possible to produce products having selected compositions of the isomers. Accordingly, a portion of the meta-para compound can be filtered off with the variously small amounts of toluene. From the toluenic filtrate and its isomeric composition in the ¹H-NMR spectrum, as well as the amount of crystals and their isomeric composition in the ¹H-NMR spectrum, it is possible to calculate and confirm the isomeric composition in the crystals more exactly. A 60 g sample of that yellowish crude product is heated and melted in 90 g of water. 90 g of toluene are added at about 80° C. The mixture is cooled slowly and crystallised, and the suspension is filtered and washed with water. The crystals are dried in vacuo. There are obtained 50 g of slightly yellowish crystals, which melt at 67-72° C. Evaluation of the ¹H-NMR spectrum in the oil from the concentrated filtrate, 7.0 g of yellowish oil, shows about 75% meta-para compound and about 25% para-para compound. On calculating back that loss to the 50 g of crystals, a new content of about 3.9% of meta-para compound in the crystals is determined. This is confirmed by evaluation of the ¹H-NMR spectrum of the crystals, which contain about 4% meta-para compound (Example 1fa).

A further 60 g sample of the yellowish crude product is heated and melted in 50 g of water. 40 g of toluene are added at about 80° C. The mixture is cooled slowly and crystallised, and the suspension is filtered and washed with water. The crystals are dried in vacuo. There are obtained 54 g of yellowish crystals, which melt at 66-72° C. Evaluation of the ¹H-NMR spectrum in the oil from the concentrated filtrate, 4.7 g of yellowish oil, shows about 75% meta-para compound and about 25% para-para compound. On calculating back that loss to the 54 g of crystals, a new content of about 6.8% of meta-para compound in the crystals is determined. This is confirmed by evaluation of the ¹H-NMR spectrum of the crystals, which contain about 7% meta-para compound (Example 1fb).

### EXAMPLE 2

### Preparation of a Water-Free Crystalline Isomeric Mixture from the Corresponding Water-Containing Isomeric Mixture

The crystalline starting material from Example 1.3a which is used melts at 68-70° C. and contains 5.02% by weight water. The crystals show an X-ray powder spectrum with the characteristic lines at a 2-theta angle of 6.69; 9.67; 13.95; 15.11; 16.35; 17.57; 19.43; 21.39; 22.17; 23.35; 25.93; 27.11; 27.79; 28.73; 34.83; 41.15.

30 g of the isomeric mixture from Example 1.3a are heated to 70° C. in 170 g of toluene, in order to dissolve the product. At 65° C., all the material has dissolved. The few drops of water cannot be separated off in a separating funnel. 10 g of water-free calcium chloride are then added to the toluene solution. Stirring is carried out for one hour at 65° C., followed by filtration. The toluene solution is concentrated in vacuum rotary evaporator and dried under a high vacuum. 25.2 g of yellowish oil are obtained, which begins to crystallise slowly after more than 24 hours. The crystals of the isomeric mixture melt at 89.2-91.2° C. and contain 0.09% by weight water according to Karl Fischer water determination. The X-ray powder spectrum with the characteristic lines at a 2-theta angle of 10.71; 11.19; 16.43; 17.25; 17.87; 21.53; 22.59; 25.99; 28.75.

### EXAMPLE 3

### Preparation of bis[4-(2-hydroxy-2-methyl-propionyl)-phenyl]-methane, Compound of Formula IIa or II

3.1) Friedel-Crafts Reaction and Separation

168.2 g (1.0 mol) of diphenylmethane, 245.1 g (2.3 mol) of isobutyric acid chloride and 150 ml of 1,2-dichlorobenzene are combined and cooled to 5-0° C. by means of an ice bath. The acylation is carried out analogously to Example 1.

After working up, the organic phase is washed with water and then concentrated in a vacuum rotary evaporator at about 60° C. and about 25 mbar. The organic phase is then concentrated completely under a high vacuum. There are obtained 395.8 g of a yellow liquid, which still contains some solvent 1,2-dichlorobenzene. This corresponds to a crude yield of 128% of theory. The product is an isomeric mixture with bis[4-(2-methyl-proplonyl)-phenyl]-methane as the main component, and 86.7% p,p-isomer, 11.1% m,p-isomer, 0.7% m,m-isomer and 1.5% p-mono compound are found in the ¹H-NMR spectrum, excluding the solvent 1,2-dichlorobenzene. The product is dissolved in 100 ml of hexane and crystallised out in a refrigerator. The crystals are filtered off, washed with cold hexane and dried in vacuo. There are obtained 169 g of white crystals, which are again dissolved in 70 ml of warm hexane. The product crystallises again and is filtered off, washed and dried. There are obtained 160 g of white crystals, which melt at 42-44° C. 97.3% para-para isomer and 2.7% meta-para isomer are now found in the GC and ¹H-NMR spectrum.

The filtrate, about 350 g, is set aside and processed separately in Example 4.1.

3.2) Enol Chlorination of p,p-diketone, bis[4-2-methyl-propionyl)-pheny]-methane

60.0 g (0.1945 mol) of recrystallized bis[4-(2-methyl-propionyl)-phenyl]-methane with 2.7% [3-2-methyl-propionyl)-phenyl-4-(2-methyl-propionyl)-phenyl]-methane from the Friedel-Crafts reaction are dissolved in 150 ml of chlorobenzene and heated to 55-60° C. by means of an oil bath. The chlorination is carried out analogously to Example 1.2. There are obtained 73.8 g of a yellowish liquid, which begins to crystallise. The product is recrystallised from 75 g of hexane and then from 65 g of methanol, filtered and dried. There are obtained 30.6 g of white crystals, which melt at 70.4-73.1° C. 99% p,p-isomer and about 1% m,p-isomer are now found in the ¹H-NMR spectrum.

3.3a) Hydrolysis of p,p-dichloro Compound, bis[4-2-chloro-(2-methyl-propionyl)-phenyl]-methane

25.0 g (0.066 mol) of bis[4-2chloro-2-methyl-propionylyphenyl]-methane from the chlorination reaction, dissolved in 30 g of toluene and 10 g of methanol, are hydrolysed analogously to Example 1, Variant 1.3a. After separation of the organic phase, the warm organic phase (about 50° C.) is diluted with solvent (30 ml of toluene), and about 3 g of water are then added thereto. The solution begins to crystallise spontaneously at about 30° C. After working up analogously to Example 1, Variant 1.3b, 19.2 g of white, granular crystals containing water of crystallisation are obtained. This corresponds to a yield of 80.8% of theory (358.44) of bis[4-(2-hydroxy-2-methyl-propionyl)-phenyl]-methane. >99% para-para isomer and <1% meta-para isomer are then found in the ¹H-NMR spectrum. The crystals melt at 77.9-78.7° C. and contain 4.82% by weight water according to Karl Fischer water determination.

3.3b) Water-Free, Isomer-Free bis[4-(2-hydroxy-2-methyl-proplonyl)-phenyl]-methane

5 g of the crystals containing water of crystallisaton (Example 3.3a) are dissolved in 50 ml of toluene and heated to 60° C. 5 g of anhydrous calcium chloride are then added, and stirring is carried out for two hours. The suspension is filtered and the filtrate is concentrated in a vacuum rotary evaporator to about 20 ml. The product begins to crystallise at room temperature overnight. The crystals are washed with a small amount of toluene and dried in vacuo. 2.8 g of white crystals are obtained. >99.5% para-para isomer and <0.5% meta-para isomer are then found in the ¹H-NMR spectrum. The crystals melt at 91.3-92.0° C. and contain <0.1% by weight water according to Karl Fischer water determination.

3.3c) Recrystallisation of the Isomer-Free Hydrolysis Product

50 g of isomer-free bis[4-(2-hydroxy-2-methyl-propionyl)-phenyl]-methane containing water of crystallisation are heated to 70° C. in 75 g of toluene in order to dissolve the product. At 68° C., all the material has dissolved. A further 7.8 g of water are added. The temperature is controlled by means of an oil bath. At 50° C., the first crystals begin to form spontaneously. When crystallisation is complete, the suspension is filtered over a suction filter and washed with 62.5 g of cold toluene. The 55.4 g of white crystals are dried in vacuo to constant weight. 44.7 g of white, granular, compact crystals containing water of crystallisation are obtained. The crystals of the isomer-free product melt at 81.8-84.3° C. and contain 5.10% by weight water according to Karl Fischer water determination. The X-ray powder spectrum with the characteristic lines at a 2-theta angle of 6.67; 9.65; 14.00; 14.85; 15.15; 15.47; 15.95; 16.41; 17.69; 19.81; 20.21; 21.39; 22.17; 22.61; 23.39; 25.91; 27.13; 27.91; 28.67. The mother liquor is concentrated in vacuo. There are obtained 1.1 g of yellowish oil, which crystallises.

### EXAMPLE 4

### Preparation of [3-(2-hydroxy-2-methyl-proplonyl)-phenyl]-[4-(2-hydroxy-2-methylproplonyl)-phenyl]-methane, Compound of Formula I

4.1) Friedel-Crafts Reaction and Separation

168.2 g (1.0 mol) of diphenylmethane, 245.1 g (2.3 mol) of isobutyric acid chloride and 150 ml of 1,2-dichlorobenzene are combined and cooled to 5-0° C. by means of an ice bath. The acylation is carried out in Example 3.1.

After working up, the organic phase is concentrated in Example 3.1 and crystallised from hexane. The crystals, bis[4-2-methyl-propionyl)-phenyl]-methane, are recrystallised from hexane again and chlorinated in Example 3.2. The filtrate, about 350 g, is processed separately in Example 4.1.

The filtrate from Example 3.1 is concentrated in a vacuum rotary evaporator and then combined with other suitable dichlorobenzene solutions from the Friedel-Crafts reaction. 100 g of water are added to the yellow solution, and the mixture is freed of the solvent, 1,2-dichlorobenzene, by means of steam distillation. The head temperature in the distillation is about 95° C. and the distillation lasts about 4 hours. About 155 ml of 1,2-dichlorobenzene are recovered. The residue is separated from the water. 170.4 g of yellowish oil are obtained. 58 g of hexane are added, and dissolution is carried out while hot The solution is cooled, to room temperature, and then cooled further by means of an ice-bath. White crystals are formed. They are filtered off and washed with about 150 g of hexane. The mother liquor is concentrated in a vacuum rotary evaporator. 80 g of yellow-reddish oil are obtained, which shows about 24% m,p-isomer in the ¹H-NMR spectrum. A further 20 g of hexane are added to the oil, and the mixture is placed in a refrigerator for the purposes of crystallisation. The liquid is decanted off and concentrated in a vacuum rotary evaporator. 45 g of yellow-reddish oil are obtained, which shows about 37% m,p-isomer in the ¹H-NMR spectrum. The various crystalline portions are dried and used for the preparation of pure p,p-isomer. The liquid portion of 45 g is separated in portions over a preparative HPLC column from Varian. Since the separation is incomplete, only the first fractions are collected at the top and the rear fractions are fed back again because they contain too much p,p-isomer. After many passes through the column, there are obtained from the front fractions 1.9 g of meta-para isomer, [3-(2-methyl-propionyl)-phenyl]-[4-2-methyl-propionyl)-phenyl]-methane, which in the GC and ¹H-NMR, contains about 94% m,p-isomer and still contains about 3% m,m-isomer and about 3% p,p-isomer. The 1.9 g of yellowish oil collected are brominated without being purified further.

4.2) Enol Bromination of m,p-diketone, [3-(2-methyl-propionyl)-phenyl]-[4-(2-methylpropionyl)-phenyl]-methane

1.96 g (6.16 mmol) of separated [3-(2-methyl-propionyl)-phenyl]-[4-(2-methyl-propionyl)-phenyl]-methane are dissolved in 20 ml of chlorobenzene, and one drop of chlorosulfonic acid is added thereto. 1.97 g (12.32 mmol) of bromine are then dissolved in 50 ml of chlorobenzene and added dropwise at room temperature in a period of about 3 hours. The conversion is checked with a ¹H-NMR spectrum. The slightly yellowish solution is concentrated in a rotary evaporator. 2.9 g of yellow oil, [3-(2-bromo-2-methyl-propionyl)-phenyl-]-[4-(2-bromo-2-methyl-propionyl)-phenyl]-methane, are obtained.

4.3) Hydrolysis of m,p-dibromo Compound, [3-(2-bromo-2-methyl-propionyl)-phenyl]-[4-(2-bromo-2-methyl-proplonyl)-phenyl]-methane

2.0 g (15 mmol) of NaOH concentrated to 30%, 20 ml of deionised water and 20 ml of methanol are combined and heated to 50° C. by means of an oil bath. 2.9 g (6.16 mmol) of [3-(2bromo-2-methyl-proplonyl)-phenyl]-[4-(2-bromo-2-methyl-propionyl)-phenyl]-mathane, dissolved in 20 ml of toluene and 10 ml of methanol, are then added dropwise, with thorough stirring, in a period of about one hour. The alkaline mixture (about pH 12) is then stirred for about three hours at 55-6° C. The conversion is checked with a ¹H-NMR sample. The mixture is then adjusted dropwise to a pH of about 1-2 with about 1.0 g of 16% hydrochloric acid and stirred at 50° C. for one hour in order to complete the reaction. The conversion is checked with a ¹H-NMR sample. When the hydrolysis is complete, the reaction mixture is neutralised with a small amount of dilute sodium hydroxide solution. The two phases are separated in a separating funnel. The organic phase is concentrated in a rotary evaporator. 2.8g of brownish oil are obtained (Example 4.3). It is dissolved in 20 ml of toluene and washed with 10 ml of water. The toluene solution is concentrated in a rotary evaporator and dried under a high vacuum. 2.0 g of yellowish oil are obtained. About 94% m,p-isomer, about 3% m,m-isomer and about 3% p,p-isomer, determined by evaluation of the integrals of the aromatic protons, are found in the ¹H-NMR spectrum. No water-containing crystals have formed from the liquid m,p-isomer.

A sample of the mother liquor from Example 1d.5 is purified by flash chromatography over silica gel 60 (0.040-0.063 mm) from Merck. A mixture of ethyl acetate:hexane mixture 1:2 is used as eluant. Very surprisingly, the largest amount of the meta-para isomer is to be found in the mother liquor and not in the crystals. About 36% para-para isomer and about 64% meta-para isomer, determined by evaluation of the integrals of the aromatic protons, are found in the ¹H-NMR spectrum (Example 1d.5a). The proportion of meta-para compound in the crystals has fallen to about 1-2%. That value is estimated from the difference with respect to the value in the mother liquor. In the ¹H-NMR spectrum of the crystals, such a low value can only be estimated roughly. An improved method of determining the distribution of isomers after crystallisation is described in Example 1e.

The proportion of meta-para compound in the chromatographed mother liquors is between 60 and 80%, in the case of previous crystallisation of the crude product with water and toluene as solvent. The proportion of meta-para compound in the crystals has in most cases fallen to about 1-3%. Those values are calculated from the differences relative to the values in the mother liquors. In the ¹H-NMR spectrum of the crystals, such low values can only be estimated roughly.

Application Example A1

UV Inkjet Test Formulation, Pigment Powder

A pigment concentrate is prepared in a bead mill using the raw materials shown in Table 1. 15 parts of the pigment concentrate are mixed with 79.50 parts of the reactive diluent (Viajet 400, UCB), 0.40 parts levelling agent (DOW Corning 57, DOW Corning), and 6 or 8 parts of the photoinitiator, to give the final ink.

TABLE 1
Composition of the pigment concentrate.

| Raw Material | Parts |
|---|---|
| Viajet 100 (UCB) | 78.45 |
| Irgalite Blue GLO (Ciba) | 20.00 |
| Florstab UV1 (Kromachem) | 1.00 |
| Solsperse 5000 (Avecia) | 0.55 |

ViaJet 100 is a unique, 100% solids pigment grinding vehicle for use in producing pigment concentrates for UV inkjet inks.
Florstab is an in-an stabilizer for UV-curing systems
Curing Performance of the UV Inkjet Test Formulations

The inks are applied to metallized paper using a 12 μm K-bar. Upon exposure to the UV light of 2 medium pressure mercury lamps (120 W/cm each), the surface cure of the inks has been testet (dry rub test with paper tissue). The cure speed corresponds to the maximum speed of the conveyor belt of the UV curing unit, at which the ink was completely cured and tack free. The observed data are shown in Table 2.

TABLE 2
Cure speed of the UV Inkjet test formulations.

Cure Speed
[m/min]

| Photoinitiator | 6% | 8% |
|---|---|---|
| Irgacure 369 | 20 | 30 |
| Irgacure 907/ITX | 20 | 30 |
| (4:1) | | |
| Photoinitiator of | 30 | 60 |
| Example 1 | | |

Application Example A2
UV Inkjet Formulation (Low Viscosity Ink), Pigment Preparation

The UV ink jet formulations used are based on a commercially available letdown vehicle such as, for example, VIAJET 400 from UCB.

First a pigment concentrate is prepared by dispersing 20 parts by weight of a pigment preparation (containing the pigment and ca 50wt % vinyl chloride co-polymer) for 15 min. with a dispermat at 15 m/s in a mixture of 65 parts by weight of VIAJET 400 and 15 parts by weight of N-vinylpyrrolidone.

25 parts by weight of the concentrate is then mixed with 75 parts by weight of the reactive diluent at a ratio of 25:75 with a magnetic stirrer to give the final ink containing 2.0-2.5 wt %o pigment and 6 to 8 wt % photoinitiator. The composition is shown in Tab. 3.

| Raw material | parts |
|---|---|
| Pigment concentrate | |
| letdown vehicle (VIAJET 400) | 65.0 |
| N-vinylpyrrolidone | 15.0 |
| Pigment preparation | 20.0 |
| containing the pigment and ca | |
| 50 wt % vinyl chloride co-polymer | |
| Reactive diluent | |
| Letdown vehicle (VIAJET 400) | 99.5 − x |
| Photoinitiator | x |
| leveling agent | 0.5 |

x = 8.0 parts for 6% photoinitiator in the final ink; 10.7 parts for 8% photoinitiator in the final ink.

Preparation A: Pigment Yellow PY151/PY110
Preparation B. Magenta Pigment preparation PR 202/PR 254
Preparation C. Copper Phthalocyanine Pigment Blue 15:3
Preparation D. Black Pigment PB 7

The pigment preparations contain approximately 50% vinyl chloride co-polymer to ensure good dispersibility and dispersion stability. The preparations have a small particle size with a narrow particle size distribution.

The ink jet formulations have viscosities in the range of 20 to 33 mpas.

Curing Performance of the UV Inkjet Test Formulations.

The inks are applied with a Citenso K Kontrol Coater to primered aluminum foil, at a layer thickness of 12 μm. They are cured to the tack-free state (dry rub test) on an IST UV curing unit equipped with two medium-pressure mercury lamps (120 W/cm each) and optionally, a nitrogen purge. The cure speed corresponds to the maximum speed of the conveyor belt of the UV curing unit, at which the ink was completely cured and tack free. The observed data are shown in Tab. 4.

TABLE 4
Cure speed of the UV Inkjet test formulations.

| Pigment | | Cure spped m/min | |
|---|---|---|---|
| Preparation | Photoinitiator | 6% Phptoinitiator | 8% Phptoinitiator |
| A | Irgacure 369 | 30 | 60 |
| | Irgacure 907 | 30 | 60 |
| | Ex. 1 | 40 | 90 |
| B | Irgacure 369 | 20 | 60 |
| | Irgacure 907 | 30 | 60 |
| | Ex. 1 | 30 | 80 |
| C | Irgacure 369 | 20 | 60 |
| | Irgacure 907 | 25 | 60 |
| | Ex. 1 | 30 | 70 |
| D | Irgacure 369 | 20 | 50 |
| | Irgacure 907 | 20 | 50 |
| | Ex. 1 | 20 | 80 |

Irgacure 369: (4-Morpholino-benzoyl)-1-benzyl-1-dimethyl-aminopropane
Irgacure 907: (4-Methylthio-benzoyl)-1-methyl-1-morpholinoethane

1. A process for preparing an ink jet printed matter, which comprises the steps of applying an ultraviolet curable ink jet ink composition comprising
a photopolymerizable monomer, oligomer or prepolymer;
a colorant and a compound of the formula I or II or Ia or IIa 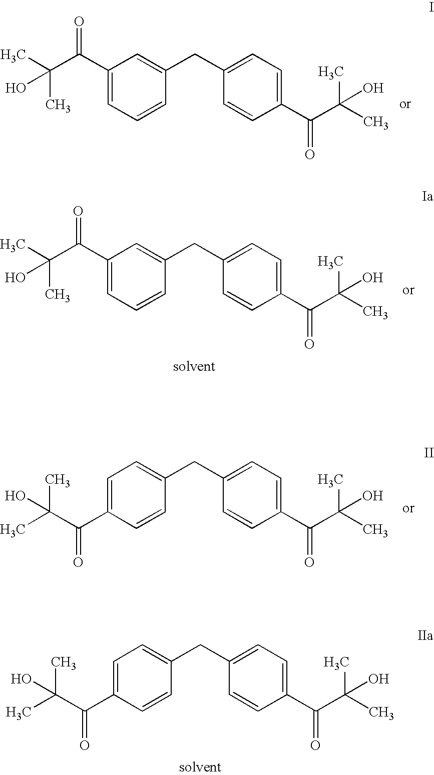
or mixtures thereof, and
optionally a reactive diluent to a recording medium and curing the ink composition on the recording medium by irradiating with ultraviolet ray.

2. A process according to claim 1, wherein the ink jet composition comprises
a photopolymerizable monomer, oligomer or prepolymer;
a colorant and a compound of the formula I or II or Ia or IIa 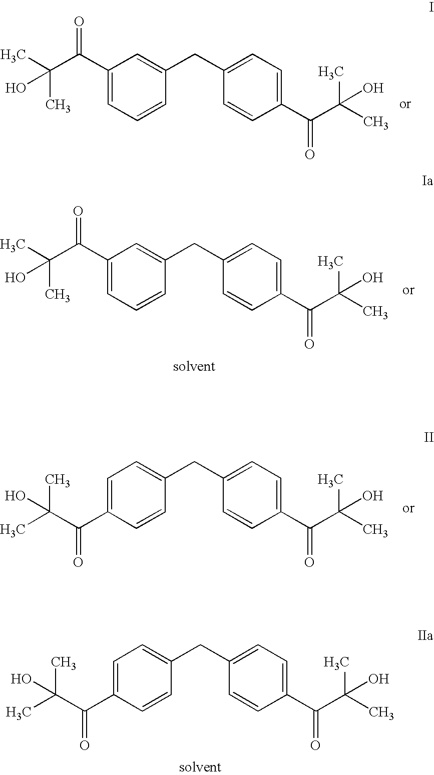
or mixtures thereof, and
a reactive diluent.

3. A process according to claim 1, wherein the inkjet ink composition is a mixture of compound Ia and IIa having a content of compound Ia of 1-2% by weight and a water content of 4-6% by weight.

4. A process according to any one of claims 1, wherein the colorant in the ink-jet ink composition is a pigment powder or a pigment preparation.

5. A process according to any one of claims 1, wherein the ink-jet ink composition processes a viscosity of less than 50 mPas at ambient temperature.

6. (canceled)

7. A process according to claim 2, wherein the ink-jet ink composition is a mixture of compound Ia and IIa having a content of compound Ia of 1-2% by weight and a water content of 4-6% by weight.

8. A process according to any one of claims 2, wherein the colorant in the ink-jet ink composition is a pigment powder or a pigment preparation.

9. A process according to any one of claims 3, wherein the colorant in the ink-jet ink composition is a pigment powder or a pigment preparation.

10. A process according to any one of claims 2, wherein the ink-jet ink composition processes a viscosity of less than 50 mPas at ambient temperature.

11. A process according to any one of claims 3, wherein the ink-jet ink composition processes a viscosity of less than 50 mPas at ambient temperature.

12. A process according to any one of claims 4, wherein the ink-jet ink composition processes a viscosity of less than 50 mPas at ambient temperature.

13. An ink jet system comprising a compound of the formula I or II or Ia or IIa.
